(19) United States
(12) Patent Application Publication
(10) Pub. No.: US 2023/0086708 A1
(43) Pub. Date: Mar. 23, 2023

(54) INDUCTION WELD JOINT FOR AN ENCLOSURE

(71) Applicant: CommScope Technologies LLC, Hickory, NC (US)

(72) Inventors: Barry Wayne Allen, Siler City, NC (US); Jos Corstjens, Meeuwen (BE); Filip DF Ponsaerts, Zoutleeuw (US)

(21) Appl. No.: 17/949,447

(22) Filed: Sep. 21, 2022

Related U.S. Application Data
(60) Provisional application No. 63/246,445, filed on Sep. 21, 2021.

(51) Int. Cl. B29C 65/36; B29C 65/00

(52) U.S. Cl. CPC B29C 65/3604; B29C 66/543; G02B 6/4441

(57) ABSTRACT

The present disclosure relates to a housing having an interior and an exterior. The housing includes a first housing piece and a second housing piece that are coupled together by a joint. The joint includes a bonding material and the joint is configured such that when the bonding material is pressurized during formation of the joint the bonding material is predisposed to move toward the interior of the housing as compared to the exterior of the housing.

### CROSS-REFERENCE TO RELATED APPLICATION

This application claims the benefit of U.S. Provisional Application No. 63/246,445, filed Sep. 21, 2021, and titled “INDUCTION WELD JOINT FOR AN ENCLOSURE” the disclosure of which is hereby incorporated herein by reference.

### TECHNICAL FIELD

The present disclosure relates generally to enclosures such as telecommunications enclosures. More particularly, the present disclosure relates to seams/joint configurations for bonding enclosure housing pieces together.

### BACKGROUND

Sealed enclosures are commonly used in the telecommunications industry to contain and protect optical components and to provide optical connection locations in the field. It is known for enclosure housing pieces to be bonded together at seams/joints such as induction weld joints. U.S. Pat. No. 7,753,596 and PCT international publication numbers WO2020/236740 and WO2020/014210 disclose example enclosures having housing pieces bonded together at seams/joints.

### SUMMARY OF THE DISCLOSURE

One aspect of the present disclosure relates to a housing having an interior and an exterior. The housing includes a first housing piece and a second housing piece that are coupled together by an induction weld strength joint. The induction weld strength joint includes a bonding material including susceptors adapted to generate heat when exposed to magnetic energy such as electromagnetic energy applied by an induction welding tool. The induction weld strength joint is configured such that when the bonding material is heated via magnetic energy, softened and pressurized during induction welding, the bonding material is predisposed to move toward the interior of the housing as compared to the exterior of the housing. By designing the induction weld strength joint such that the bonding material flows toward the interior of the housing as compared to the exterior of the housing during induction welding, bonding material is prevented from flowing outside the housing. This is beneficial from an aesthetic perspective particularly in cases in which the bonding material includes ferromagnetic material that can be subject to unsightly rusting. It will be appreciated that the bonding material can be predisposed to move toward the interior of the housing by constructing the induction weld strength joint with features that force the bonding material in an inward direction during the welding process and that also include features such as a vent gap, venting notches, or flexible inner walls that accommodate inward movement of the bonding material as the bonding material flows and is pressurized within a joint channel of the induction weld strength joint.

The present disclosure also relates to a housing having an interior and an exterior. The housing includes a first housing piece and a second housing piece that are coupled together by a joint. The joint includes a bonding material and is configured such that when the bonding material is pressurized during formation of the joint the bonding material is predisposed to move toward the interior of the housing as compared to the exterior of the housing.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular examples of the present disclosure and therefore do not limit the scope of the present disclosure. Examples of the present disclosure will hereinafter be described in conjunction with the appended drawings, wherein like numerals denote like elements.

FIG. 1 depicts an enclosure including housing pieces that can be joined together using induction weld strength joints in accordance with the principles of the present disclosure;

FIG. 2 is an exploded view of a first induction weld strength joint configuration in accordance with the principles of the present disclosure for coupling together first and second housing pieces;

FIG. 3 depicts the first induction weld strength joint configuration in a bonded state in which the first and second housing pieces are joined together by the first induction weld strength joint;

FIG. 4 depicts a shape of a volume of bonding material of the first induction weld strength joint after the first and second housing pieces have been joined together;

FIG. 5 is an exploded view of a second induction weld strength joint configuration in accordance with the principles of the present disclosure for coupling together first and second housing pieces;

FIG. 6 depicts the second induction weld strength joint configuration in a bonded state in which the first and second housing pieces are joined together by the second induction weld strength joint;

FIG. 7 depicts a shape of a volume of bonding material of the second induction weld strength joint after the first and second housing pieces have been joined together;

FIG. 8 is an exploded view of a third induction weld strength joint configuration in accordance with the principles of the present disclosure for coupling together first and second housing pieces;

FIG. 9 depicts the third induction weld strength joint configuration in a bonded state in which the first and second housing pieces are joined together by the third induction weld strength joint;

FIG. 10 depicts a shape of a volume of bonding material of the third induction weld strength joint after the first and second housing pieces have been joined together;

FIG. 11 is an exploded view of a fourth induction weld strength joint configuration in accordance with the principles of the present disclosure for coupling together first and second housing pieces;

FIG. 12 depicts the fourth induction weld strength joint configuration in a bonded state in which the first and second housing pieces are joined together by the fourth induction weld strength joint;

FIG. 13 depicts a shape of a volume of bonding material of the fourth induction weld strength joint after the first and second housing pieces have been joined together;

FIG. 14 is an exploded view of a fifth induction weld strength joint configuration in accordance with the principles of the present disclosure for coupling together first and second housing pieces;

FIG. 15 depicts the fifth induction weld strength joint configuration in a bonded state in which the first and second housing pieces are joined together by the fifth induction weld strength joint;

FIG. 16 depicts a shape of a volume of bonding material of the fifth induction weld strength joint after the first and second housing pieces have been joined together;

FIG. 17 is an exploded view of a sixth induction weld strength joint configuration in accordance with the principles of the present disclosure for coupling together first and second housing pieces;

FIG. 18 depicts the sixth induction weld strength joint configuration in a bonded state in which the first and second housing pieces are joined together by the sixth induction weld strength joint;

FIG. 19 depicts a shape of a volume of bonding material of the sixth induction weld strength joint after the first and second housing pieces have been joined together;

FIG. 20 is an exploded view of a seventh induction weld strength joint configuration in accordance with the principles of the present disclosure for coupling together first and second housing pieces;

FIG. 21 depicts the seventh induction weld strength joint configuration in a bonded state in which the first and second housing pieces are joined together by the seventh induction weld strength joint; and

FIG. 22 depicts a shape of a volume of bonding material of the seventh induction weld strength joint after the first and second housing pieces have been joined together.

### DETAILED DESCRIPTION

Various examples will be described in detail with reference to the drawings, wherein like reference numerals represent like parts and assemblies throughout the several views.

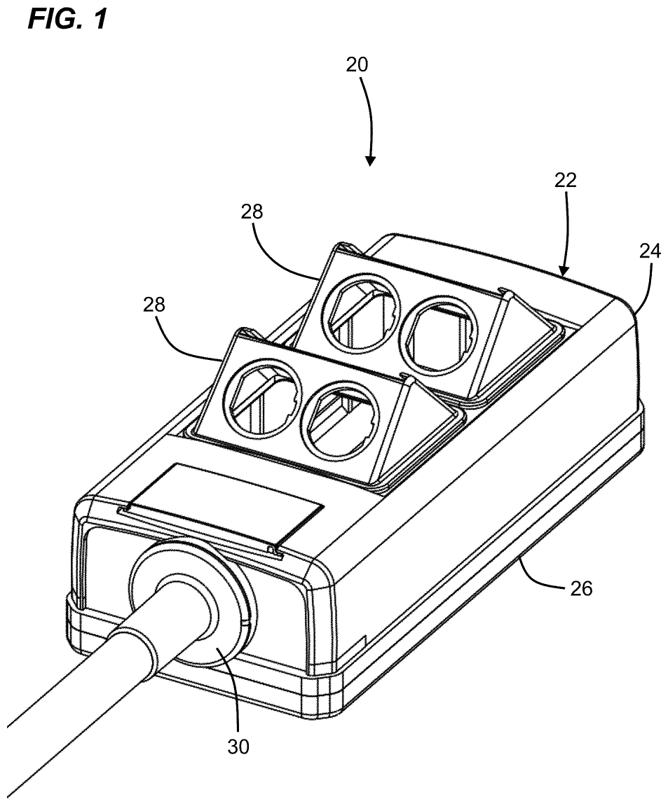

FIG. 1 depicts a telecommunications enclosure 20 including a housing 22 having housing pieces that can be coupled together by induction weld strength joints in accordance with the principles of the present disclosure. For example, the housing 22 includes a cover 24 and a base 26 that can be coupled together and sealed by an induction weld strength joint in accordance with the principles of the present disclosure. Also, the housing 22 includes adapter carriers 28 that can be coupled to the cover 24 by induction weld strength joints in accordance with the principles of the present disclosure. Further, the housing 22 includes a cable anchor 30 that can be coupled to the end of the cover 24 by an induction weld strength joint in accordance with the principles of the present disclosure. It will be appreciated that induction weld strength joints in accordance with the principles of the present disclosure are preferably configured to provide the dual function of bonding two housing pieces together, and also to provide sealing between the housing pieces at the strength joint location.

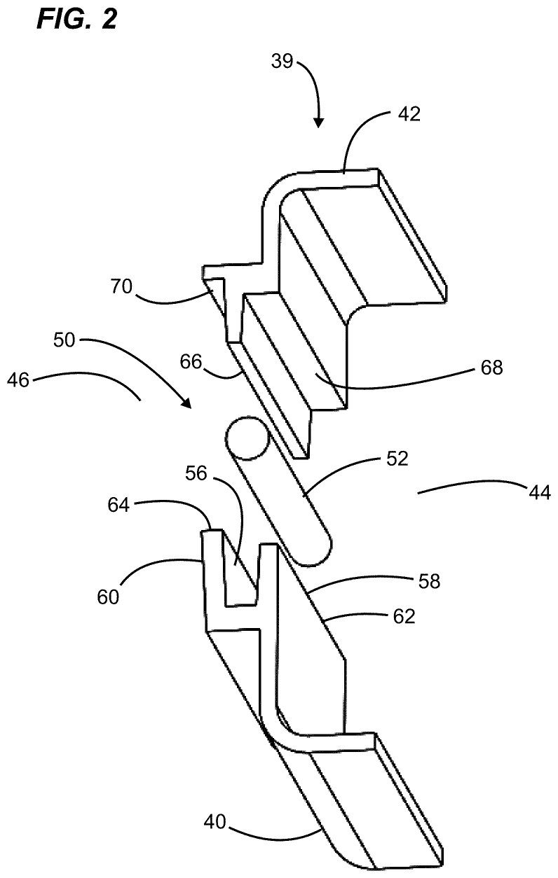

FIG. 2 shows a portion of a housing 39 including a first housing piece 40 and a second housing piece 42. The housing 39 has an interior 44 and an exterior 46. The first and second housing pieces 40, 42 are adapted to be coupled together by an induction weld strength joint 50. The induction weld strength joint 50 includes a bonding material 52 including a susceptor adapted to generate heat when exposed to magnetic energy such as electromagnetic energy generated by one or more inductive coils of an induction welding tool. The induction weld strength joint 50 has a preferred vent path 54 that extends toward the interior 44 of the housing 39 such that when the bonding material 55 is heated via magnetic energy, softened and pressurized during induction welding, the bonding material 52 is predisposed to vent/flash toward the interior 44 of the housing 39 as compared to the exterior 46 of the housing 39.

The first housing piece 40 defines a joint channel 56 for receiving the bonding material 52. The bonding material 52 can be applied into the joint channel 56 as a cord (e.g., a bead, filament, etc.). The joint channel 56 is defined by an inner channel wall 58 and an outer channel wall 60. The inner channel wall has an upper end 62 and the outer channel wall 60 has an upper end 64. The second housing piece 42 includes a joint pressurization rib 66 adapted to project into the joint channel 56 when the first and second housing pieces 40, 42 are mated together to pressurize the bonding material 52. The second housing piece includes an inner overhang 68 and an outer overhang 70. When the first and second housing pieces 40, 42 are mated together, the inner overhang 68 opposes the upper end 62 of the inner channel wall 58 in the outer overhang 70 opposes the upper end 64 of the outer channel wall 60. When the first and second housing pieces 40, 42 are mated together, the outer overhang 70 seats on the upper end 64 of the outer channel wall 60 and a vent gap 72 is defined between the inner overhang 68 and the upper end 62 of the inner channel wall 58. The vent gap 72 is sized and shaped such that during induction welding in which the first and second housing pieces 40, 42 are forced together in a fixture, sufficient hydraulic load is applied to the bonding material 52 to allow for effective induction welding while providing sufficient venting for allowing controlled flashing of a portion of the bonding material 52 in the inward direction.

It will be appreciated that the geometry of the strength joint 50 and other strength joints disclosed herein is adapted to accommodate a volume of bonding material (e.g., a cord volume) of at least 105%, 110%, 120%, 150%, 175%, or 200% over nominal volume of primary seal.

To install the induction weld strength joint 50, the bonding material 52, which can be applied as a cord, is aligned between the first and second housing pieces 40, 42 and inserted into the joint channel 56. With the bonding material 52 inserted in the joint channel 56, the housing pieces 40, 42 can be positioned within a fixture which is used to force the first and second housing pieces 40, 42 together such that the joint pressurization rib 66 moves into the joint channel 56 and applies pressure to the bonding material 52. In one example the joint pressurization rib 66 has a wedge shape and is configured to force the bonding material 52 more in an inward direction as compared to an outward direction as the first and second housing pieces 40, 42 are forced together. In one example, the joint pressurization rib 66 is closer to the outer channel wall 60 than the inner channel wall 58. In one example, the joint pressurization rib 66 slides against the outer channel wall 60 and is offset from the inner channel wall 58. As pressure is applied to the bonding material 52 by the joint pressurization ribs 66, electromagnetic energy is applied to the bonding material causing the susceptors of the bonding material to be heated and to transfer heat to surrounding polymeric material of the bonding material 52 causing the bonding material to soften.

In other examples, the bonding material may be installed (e.g., dispensed, applied, placed, located) in in the joint channel in other forms such as a pre-formed gasket, a pre-formed metal piece, or other structure.

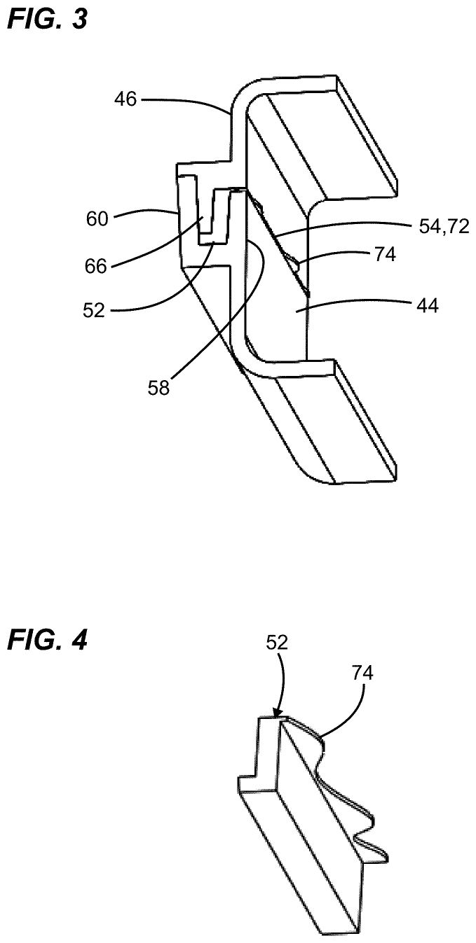

As the bonding material softens, the bonding material 52 is capable of flowing in response to the pressure applied by the joint pressurization rib 66. Preferably, the softened bonding material 52 flows to fill void areas within the joint channel 56. As indicated above, the bonding material 52 flows toward the interior 44 of the housing 39 and the geometry of the joint channel 56 maintains primary containment of the bonding material 52 such that sufficient hydrostatic pressure is maintained on the bonding material to allow for effective inductive welding. The vent gap 72 is configured to allow some of the bonding material 52 to flash in a direction toward the interior 44 of the housing 39 while allowing the remainder of the bonding material 52 to remain under sufficient hydrostatic pressure to allow for effective inductive welding. Once the bonding material 52 has flowed to fill the voids within the joint channel 56, the electromagnetic energy is discontinued and the bonding material 52 is allowed to cool while pressure is maintained between the first and second housing pieces 40, 42. As the bonding material 52 cools, the bonding material bonds to the surfaces of the first and second housing pieces 40, 42 against which it contacts. For example, the bonding material 52 bonds and seals against the inner side of the joint pressurization rib 66, the bottom of the joint channel 56, the inner side of the inner channel wall 58 and against the inner overhang 68. FIG. 3 shows the induction weld strength joint 50 after the bonding material 52 has flowed to fill voids within the joint channel 56 and a flash portion 74 of the bonding material 52 has flashed through the vent gap 72 toward the interior 44 of the housing 39. FIG. 4 depicts the shape of the volume of bonding material 52 after the bonding material 52 has flowed to fill voids within the joint channel 56 and flashed through the vent gap 72.

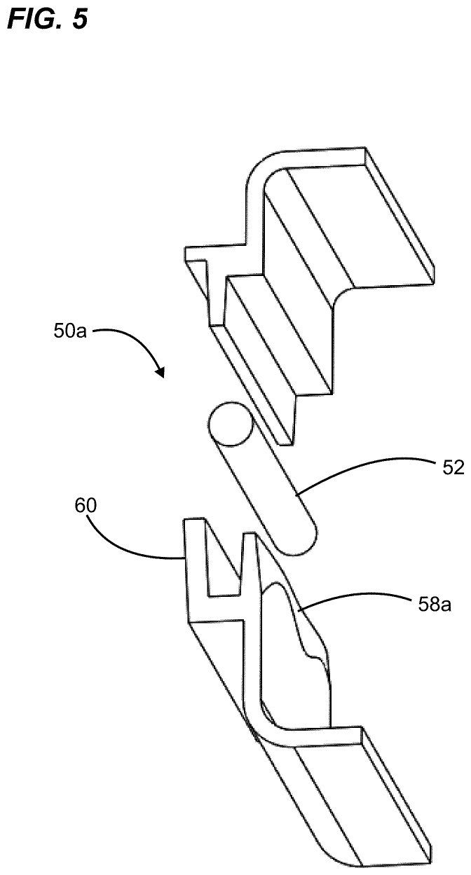

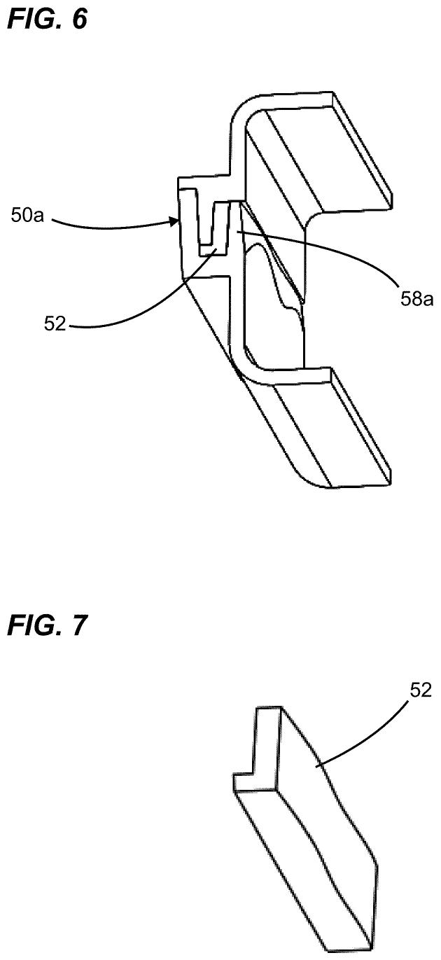

FIGS. 5 and 6 depict another induction weld strength joint 50a in accordance with the principles of the present disclosure. The induction weld strength joint 50a has a similar configuration as the strength joint 50 except the vent gap 72 has been replaced by an inner channel wall 58a that is configured to flex inwardly to accommodate inward movement of bonding material 52 during the induction welding process. In the depicted example, the inner channel wall 58a is more flexible than the outer channel wall 60 such as that the inner channel wall 50a is adapted to flex inwardly to accommodate inward movement of the bonding material 52 within the joint channel. In one example, the inner channel wall 58a can have a tapered configuration. In certain examples, the inner channel wall 58a is at least 10%, 20%, 30%, 40% or 50% more flexible than the outer channel wall 60. In certain examples, the inner channel wall 58a is at least 10%, 20%, 30%, 40%, or 50% thinner than the outer channel wall 60 in an outward-to-inward orientation. In certain examples, the inner channel wall 58a is configured to flex more in an inward direction than the outer channel wall 60 is configured to flex in an outer direction. FIG. 5 shows the induction weld strength joint 50a prior to pressing the housing pieces together, and FIG. 6 shows the induction weld strength joint 50a after the bonding material 52 has flowed within the joint channel under pressure to cause inward movement (e.g., flexing, bulging, etc.) of the inner channel wall 50a to accommodate the bonding material 52. FIG. 7 shows the shape of the bonding material after the induction welding process has been completed and the inner wall has flexed inwardly. The bonding material is shown in isolation from the housing pieces.

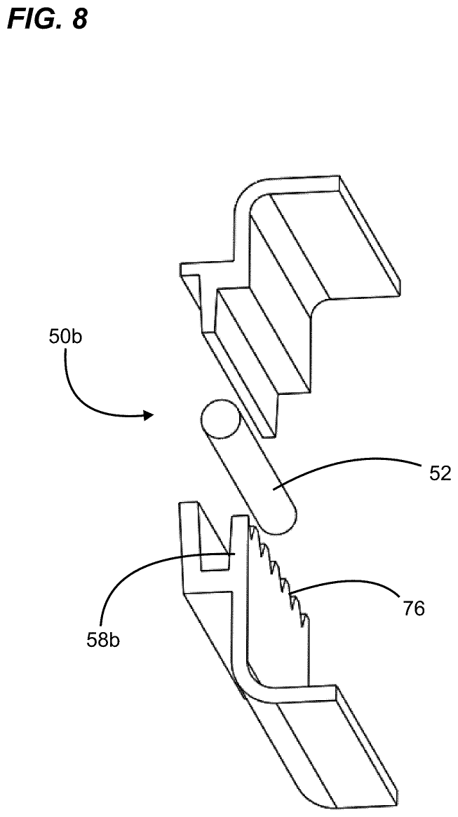

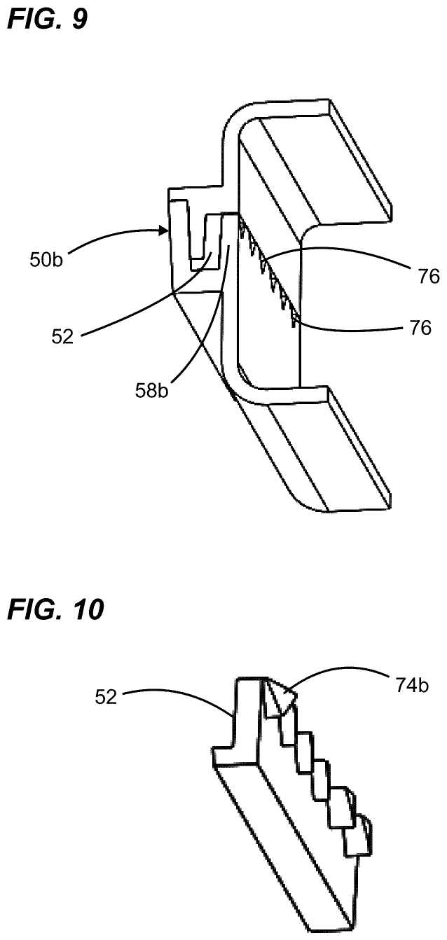

FIGS. 8 and 9 depict another induction weld strength joint 50b in accordance with the principles of the present disclosure. The induction weld strength joint 50b has a similar configuration as the strength joint 50 except the vent gap 72 has been replaced by an inner channel wall 58b having vent notches 76 at the interface between the upper end of the inner channel wall and the inner overhang. FIG. 8 shows the induction weld strength joint 50b prior to compressing the housing pieces together, and FIG. 9 shows the induction weld strength joint 50b after the bonding material 52 has flowed within the joint channel under pressure to fill voids within the joint channel and to cause a flash portion 74b of the bonding material 52 to extrude through the vent notches 76. FIG. 10 shows the shape of the bonding material after the induction welding process has been completed and the bonding material has conformed to the shape of the joint channel and extruded through the vent notches 76. The bonding material is shown in isolation from the housing pieces.

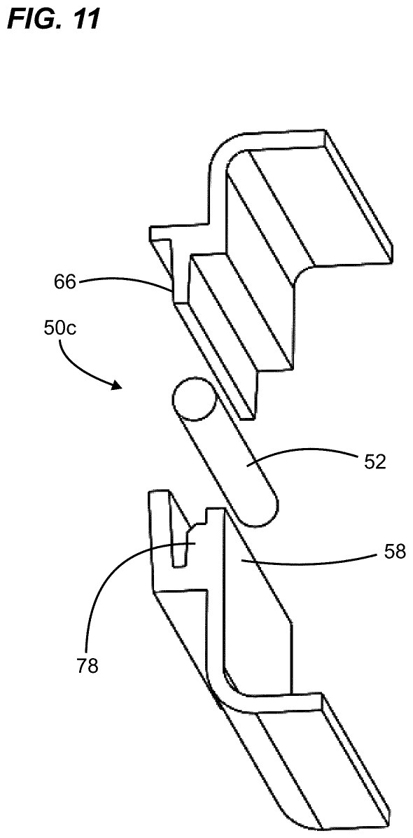

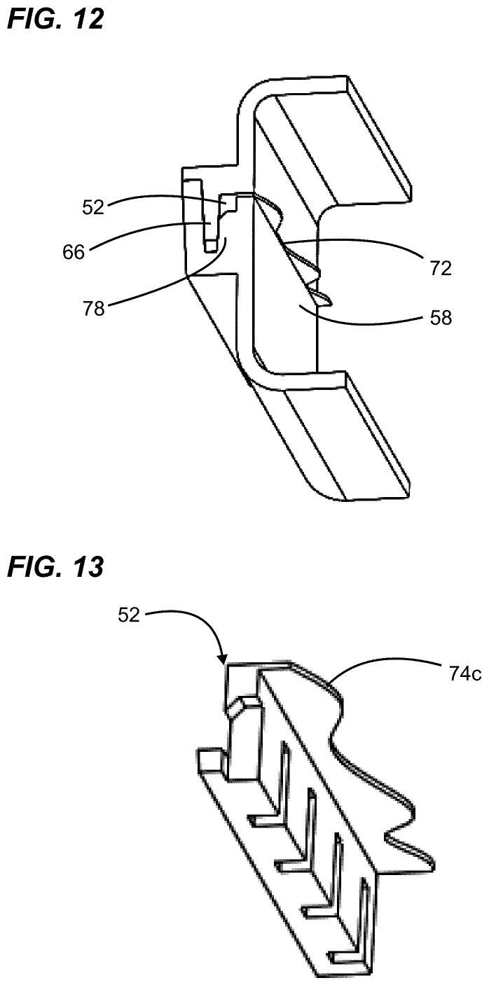

FIGS. 11 and 12 depict another induction weld strength joint 50c in accordance with the principles of the present disclosure. The induction weld strength joint 50c has a similar configuration as the strength joint 50 except the supplemental pressurization ribs 78 have been added to the inner side of the inner channel wall 58 within the joint channel to provide increased pressurization of the bonding material during the induction welding process. The supplemental pressurization ribs 78 are parallel and are transversely oriented relative to the inner channel wall 58 and the joint pressurization rib 66. In one example, the bonding material flows (e.g., extrudes) between the supplemental pressurization ribs 78 as the bonding material 52 is heated and pressurized during induction welding. FIG. 11 shows the induction weld strength joint 50c prior to compressing the housing pieces together, and FIG. 12 shows the induction weld strength joint 50c after the bonding material 52 has flowed within the joint channel under pressure to fill voids within the joint channel and to cause a flash portion 74c of the bonding material 52 to extrude through the vent gap 72. FIG. 13 shows the shape of the bonding material after the induction welding process has been completed and the bonding material has conformed to the shape of the joint channel, filled the regions between the supplemental pressurization ribs 78 and extruded through the vent gap 72. The bonding material is shown in isolation from the housing pieces.

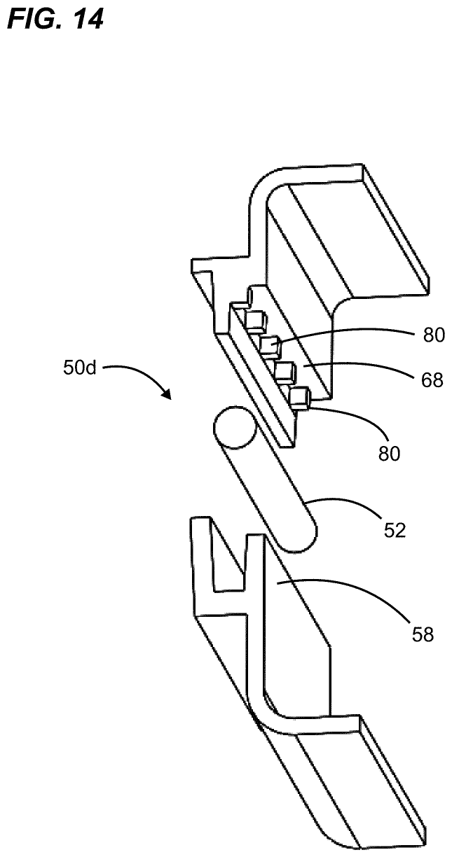

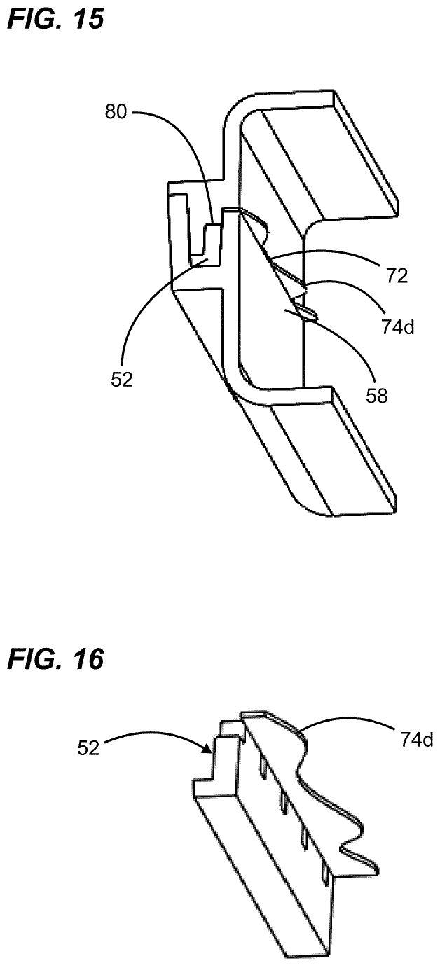

FIGS. 14 and 15 depict another induction weld strength joint 50d in accordance with the principles of the present disclosure. The induction weld strength joint 50d has a similar configuration as the strength joint 50 except the supplemental pressurization ribs 80 have been added to the inner overhang 68 to provide increased pressurization of the bonding material during the induction welding process. The supplemental pressurization ribs 80 are parallel and are transversely oriented relative to the inner channel wall 58 and the joint pressurization rib 66. In one example, the bonding material flows (e.g., extrudes) between the supplemental pressurization ribs 80 as the bonding material 52 is heated and pressurized during induction welding. FIG. 14 shows the induction weld strength joint 50d prior to compressing the housing pieces together, and FIG. 15 shows the induction weld strength joint 50d after the bonding material 52 has flowed within the joint channel under pressure to fill voids within the joint channel and to cause a flash portion 74d of the bonding material 52 to extrude through the vent gap 72. FIG. 16 shows the shape of the bonding material after the induction welding process has been completed and the bonding material has conformed to the shape of the joint channel, filled the regions between the supplemental pressurization ribs 80 and extruded through the vent gap 72. The bonding material is shown in isolation from the housing pieces.

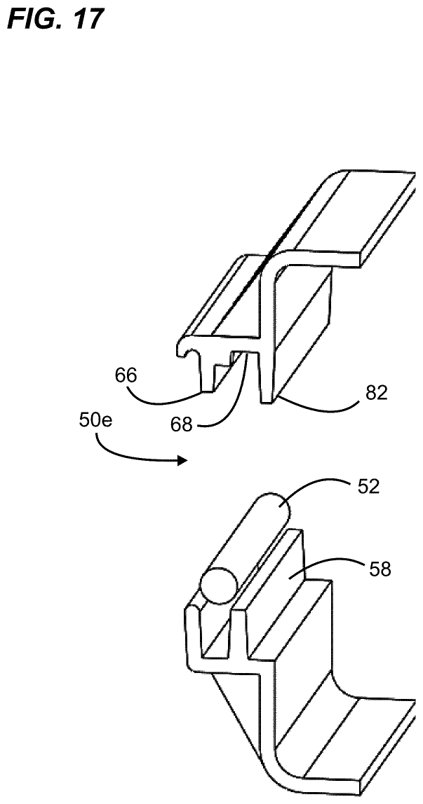

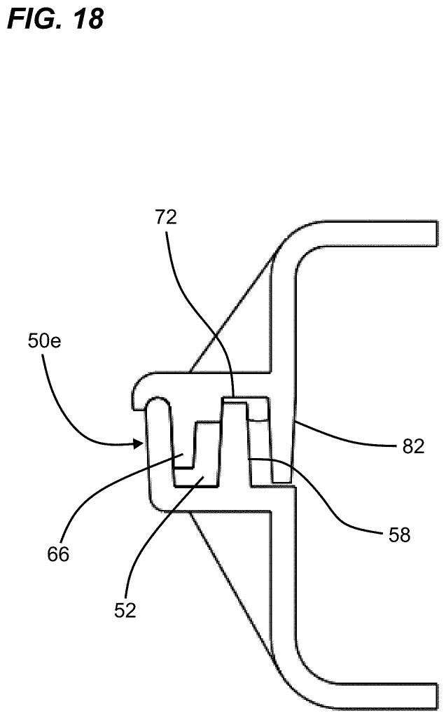

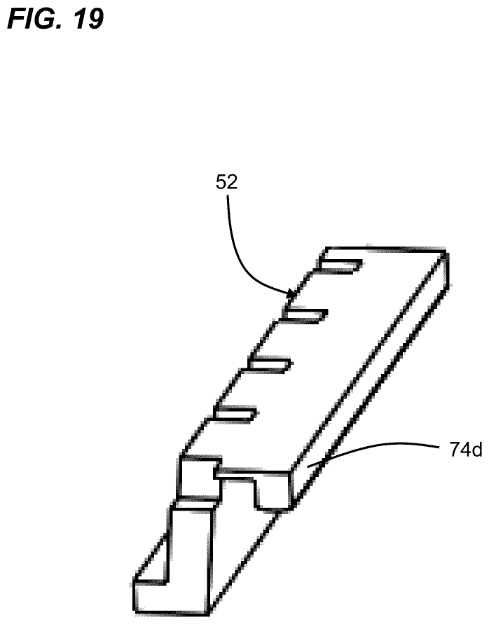

FIGS. 17 and 18 depict another induction weld strength joint 50e in accordance with the principles of the present disclosure. The induction weld strength joint 50e has a similar configuration as the strength joint 50 except a deflection rib 82 has been added to project downwardly from the inner overhang 68 on the inner side of the inner channel wall 58. The deflection rib 82 is parallel to the joint pressurization rib 66 and extends downwardly past the inner channel wall 58 at an inner side of the inner channel wall 58 when the housing pieces are mated together as shown at FIG. 18. The deflection rib 82 assist in containing bonding material 52 that extrudes through the vent gap 72. FIG. 17 shows the induction weld strength joint 50e prior to compressing the housing pieces together, and FIG. 18 shows the induction weld strength joint 50e after the bonding material 52 has flowed within the joint channel under pressure to fill voids within the joint channel and to cause a flash portion of the bonding material 52 to extrude through the vent gap 72 and into engagement with the deflection rib 82. FIG. 19 shows the shape of the bonding material after the induction welding process has been completed and the bonding material has conformed to the shape of the joint channel and extruded through the vent gap 72 into contact with the deflection rib 82. The bonding material is shown in isolation from the housing pieces.

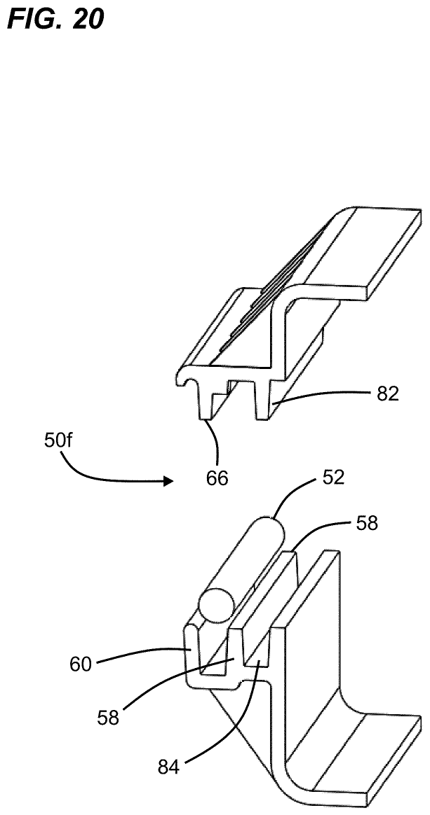

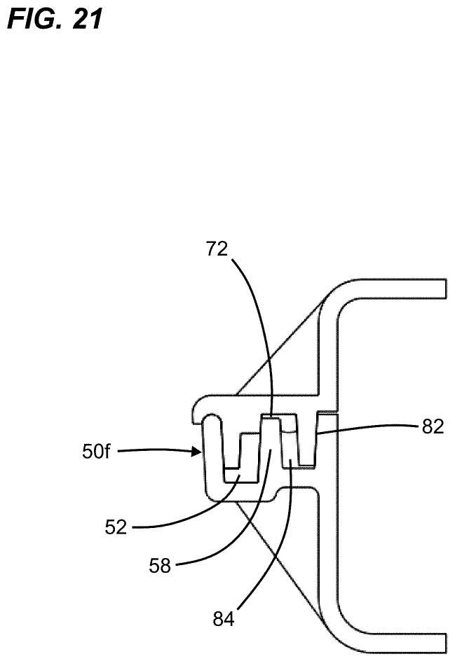

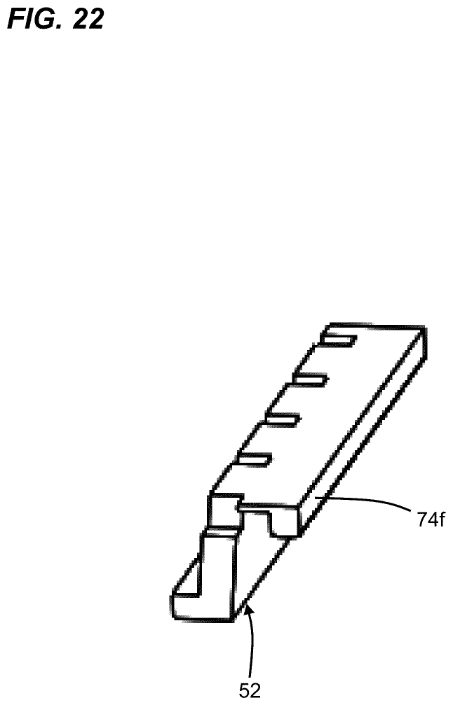

FIGS. 20 and 21 depict another induction weld strength joint 50f in accordance with the principles of the present disclosure. The induction weld strength joint 50f has a similar configuration as the induction weld strength joint 50e except an inner channel 84 has been added parallel to the joint channel into which the bonding material from the joint channel can be vented. The deflection rib 82 fits in the inner channel 84 when the housing pieces are mated together. FIG. 20 shows the induction weld strength joint 50f prior to compressing the housing pieces together, and FIG. 21 shows the induction weld strength joint 50f after the bonding material 52 has flowed within the joint channel under pressure to fill voids within the joint channel and to cause a flash portion 74f of the bonding material 52 to extrude through the vent gap 72 and into engagement with the deflection rib 82 within the inner channel 84. FIG. 22 shows the shape of the bonding material after the induction welding process has been completed and the bonding material has conformed to the shape of the joint channel and extruded through the vent gap 72 into contact with the deflection rib 82 within the inner channel 84. The bonding material is shown in isolation from the housing pieces.

In certain examples, the induction weld strength joint can include a bonding material having magnetically active particles to activate the strength seal. To activate the strength seal, an electromagnetic field is introduced to the strength seal. The electromagnetic field induces eddy currents in the magnetically active particles, which heats the particles. Heating the particles softens the thermoplastic material and allows the material to flow within the joint channel and bond to surfaces of the joint to provide sealing and to couple the housing pieces together. The housing pieces desired to be coupled together preferably compressed together while the strength seal is activated. Upon cooling, the thermoplastic material hardens, thereby bonding the bonding housing pieces together at the region corresponding to the strength joint. One example embodiment employs EMABOND™ commercially available from Ashland Specialty Chemical Company of Ohio as the thermoplastic material with embedded magnetically active particles. Additional information relating to strength seals can be found in U.S. Pat. No. 7,753,596, which is hereby incorporated by reference in its entirety.

In certain examples, the bonding material of the induction weld strength joint can include a polymeric material (e.g., a plastic material such as a thermoplastic material) that includes susceptors adapted to absorb magnetic energy (e.g., electromagnetic energy from an induction coil such as an induction coil energized with a radio-frequency electrical current) when exposed to the magnetic energy during induction welding. In one example, the susceptors are dispersed (e.g., embedded) throughout the polymeric material. Absorption of the magnetic energy causes the susceptors to be heated. As the susceptors are heated, heat from the susceptor flows to the surrounding polymeric material by thermal conduction causing the polymeric material to soften and become flowable. As the polymeric material softens and becomes flowable, pressure applied between the housing pieces desired to be coupled together cause the polymeric material to flow to fill void regions within the joint channel between the housing piece thereby enhancing sealing between the housing pieces. Upon cooling, the polymeric material bonds to the portions of the first and second housing pieces defining the region of the strength joint to form a weld/bond between the first and second housing pieces. In one example, the polymeric material is formulated with susceptors such as metallic or ferromagnetic compounds.

While a preferred application for aspects in accordance with the principles of the present disclosure relates to induction welding processes using bonding materials including susceptors, such aspects are also application to other bonding materials that flow under pressure when forming a joint such as two-part epoxies, mastics, glues and caulking.

From the forgoing detailed description, it will be evident that modifications and variations can be made in the devices of the disclosure without departing from the spirit or scope of the invention.

What is claimed is:

1. An enclosure comprising:
a housing having an interior and an exterior, the housing including a first housing piece and a second housing piece that are coupled together by an induction weld strength joint, the induction weld strength joint including a bonding material including susceptors adapted to generate heat when exposed to magnetic energy, wherein the induction weld strength joint has a preferred vent path that extends toward the interior of the housing such that when the bonding material is heated via magnetic energy, softened and pressurized during induction welding, the bonding material is predisposed to vent toward the interior of the housing as compared to the exterior of the housing.

2. The enclosure of claim 1, wherein the bonding material includes a polymeric material including the susceptors.

3. The enclosure of claim 2, wherein the susceptors include a metallic material.

4. The enclosure of claim 2, wherein the susceptors include a ferromagnetic material.

5. The enclosure of claim 2, wherein the polymeric material includes a thermoplastic material.

6. The enclosure of claim 1, wherein the first housing piece defines a joint channel for receiving the bonding material, the joint channel being defined by an inner channel wall and an outer channel wall, the inner and outer channel walls each having an upper end, the second housing piece including a joint pressurization rib that projects into the joint channel when the first and second housing pieces are mated together to pressurize the bonding material, the second housing piece including an inner overhang and an outer overhang, wherein when the inner overhang opposes the upper end of the inner channel wall when the first and second housing pieces are mated together, and wherein the outer overhang opposes the upper end of the outer channel wall when the first and second housing pieces are mated together.

7. The enclosure of claim 6, wherein the bonding material is initially installed as a cord, a pre-formed gasket or a pre-formed metal piece.

8. The enclosure of claim 6, wherein the joint pressurization rib is configured to force the bonding material more in an inward direction as compared to an outward direction as the first and second housing pieces are mated together.

9. The enclosure of claim 8, wherein the joint pressurization rib is closer to outer channel wall than the inner channel wall.

10. The enclosure of claim 8, wherein the joint pressurization rib slides against outer channel wall and is offset from inner channel wall.

11. The enclosure of claim 8, wherein the joint pressurization rib has a wedge shape.

12. The enclosure of claim 8, wherein the outer overhang seats on the upper end of the outer channel wall when the first and second housing pieces are mated together, and wherein a vent gap is defined between the inner overhang and the upper end of the inner channel wall when the first and second housing pieces are mated together.

13. The enclosure of claim 8, wherein the outer overhang seats on the upper end of the outer channel wall when the first and second housing pieces are mated together, and wherein vent notches are defined at an interface between the inner overhang and the upper end of the inner channel wall when the first and second housing pieces are mated together.

14. The enclosure of claim 13, wherein the vent notches are defined by the upper end of the inner channel wall.

15. The enclosure of claim 8, wherein the outer overhang seats on the upper end of the outer channel wall when the first and second housing pieces are mated together, and wherein a vent region is defined at an interface between the inner overhang and the upper end of the inner channel wall when the first and second housing pieces are mated together, and wherein supplemental pressurization ribs transversely oriented relative to the joint pressurization ribs are positioned in the joint channel at least when the first and second housing pieces are mated together.

16. The enclosure of claim 15, wherein the supplemental pressurization ribs are integrated with the second housing piece.

17. The enclosure of claim 15, wherein the supplemental pressurization ribs are integrated with the first housing piece.

18. The enclosure of claim 6, wherein the second housing piece includes a deflection rib parallel to the joint pressurization rib that extends past downwardly the inner channel wall at an inner side of the inner channel wall when the first and second housing pieces are mated together.

19. The enclosure of claim 18, wherein the first housing piece defines an inner channel parallel to the joint channel into which bonding material from the joint channel can be vented, and wherein the reflection rib fits within the inner channel.

20. An enclosure comprising:
a housing having an interior and an exterior, the housing including a first housing piece and a second housing piece that are coupled together by a joint, the joint including a bonding material and the joint being configured such that when the bonding material is pressurized during formation of the joint the bonding material is predisposed to move toward the interior of the housing as compared to the exterior of the housing.

21. The enclosure of claim 20, wherein the first housing piece defines a joint channel for receiving the bonding material, the joint channel being defined by an inner channel wall and an outer channel wall, the inner and outer channel walls each having an upper end, the second housing piece including a joint pressurization rib that projects into the joint channel when the first and second housing pieces are mated together to pressurize the bonding material, the second housing piece including an inner overhang and an outer overhang, wherein when the inner overhang opposes the upper end of the inner channel wall when the first and second housing pieces are mated together, and wherein the outer overhang opposes the upper end of the outer channel wall when the first and second housing pieces are mated together, and wherein the inner channel wall is more flexible than the outer channel wall such that inner channel wall is adapted to flex inwardly to accommodate inward movement of the bonding material within the joint channel.

22. The enclosure of claim 21, wherein the inner wall is at least 10%, 20%, 30%, 40%, or 50% more flexible than the outer channel wall.

23. The enclosure of claim 21, wherein the inner wall is at least 10%, 20%, 30%, 40%, or 50% thinner than the outer channel wall in an outward-to-inward orientation.

24. The enclosure of claim 21, wherein the inner channel wall is configured to flex more in an inward direction than the outer channel wall is configured to flex in an outer direction.

25. The enclosure of claim 20, wherein the joint defines a preferred vent path for encouraging the bonding material to flow toward the interior of the enclosure.

26. The enclosure of claim 20, wherein the bonding material includes susceptors and is pressurized during an induction molding process.

27. The enclosure of claim 20, wherein the bonding material includes two-part epoxy, a mastic material, a glue or a caulk.
